(19) United States
(12) Patent Application Publication
(10) Pub. No.: US 2023/0192964 A1
(43) Pub. Date: Jun. 22, 2023

(54) Daisy Chain Polymers Synthesized Employing an Energy Ratchet Mechanism

(71) Applicant: Northwestern University, Evanston, IL (US)

(72) Inventors: James Fraser Stoddart, Evanston, IL (US); Kang Cai, Evanston, IL (US); Yi Shi, Evanston, IL (US)

(21) Appl. No.: 17/999,670

(22) PCT Filed: May 24, 2021
(86) PCT No.: PCT/US2021/070599

§ 371 Date: Nov. 22, 2022

Related U.S. Application Data
(60) Provisional application No. 63/028,894, filed on May 22, 2020.

(51) Int. Cl. C08G 83/00

(52) U.S. Cl. CPC C08G 83/008

(57) ABSTRACT

Disclosed herein are daisy chain polymers and methods of making daisy chain polymers under redox control employing an energy ratchet mechanism using a molecular-pump-containing monomer comprising a recognition site and a Coulombic barrier.

### CROSS-REFERENCE TO RELATED APPLICATIONS

This application claims benefit of priority to U.S. Patent Application Ser. No. 63/028,894, filed May 22, 2020, the contents of which is incorporated herein by reference in its entirety.

### BACKGROUND

Mechanically bonded polymers constitute a class of desirable, yet challenging, synthetic targets in macromolecular science. Among them, polyrotaxanes have captured a considerable amount of attention, not only because of their exotic architectures, but also as a result of their promising applications, including in slide-ring gels, in battery electrode materials, and in drug delivery systems. There are two commonly used synthetic protocols when it comes to making polyrotaxanes. The first one is the “threading-followed-by-stoppering” approach, and the other one is the “threading-followed-by-polymerization” method. In both these instances, the polyrotaxanes are obtained under thermodynamic equilibrium, forming mechanically bonding dumbbells terminated by sterically bulky stoppers. However, there exists a need for new mechanically bonded polymers as well as methods that enable both polymerization and depolymerization of the same.

### BRIEF SUMMARY OF THE INVENTION

Disclosed herein are daisy chain polymers and methods of making daisy chain polymers under redox control employing an energy ratchet mechanism using a molecular-pump-containing monomer.

One aspect of the technology provides for daisy chain polymers. The daisy chain polymer may comprise a multiplicity of molecular-pump-containing monomers. The molecular-pump-containing monomers comprise a molecular pump having a recognition site and a Coulombic barrier. In some embodiments, the molecular-pump-containing monomers are kinetically trapped. In some embodiments, the molecular-pump-containing monomers are host-guest paired.

In some embodiments, the molecular-pump-containing monomers further comprise a redox-active macrocyclic component and a collecting chain. In some embodiments, the redox-active macrocyclic component of one molecular-pump-containing monomer is kinetically trapped on the collecting chain of another molecular-pump-containing monomer. In some embodiments, the redox-active macrocyclic component of one molecular-pump containing monomer is host-guest paired with the recognition site of another molecular-pump-containing monomer. In some embodiments, the recognition site comprises a viologen subunit. In some embodiments, the Coulombic barrier comprises a dimethylpyridinium. In some embodiments, the redox-active macrocyclic component comprises a cyclobis(paraquat-p-phenylene) (CBPQT) macrocycle. In some embodiments, the molecular-pump-containing monomers are

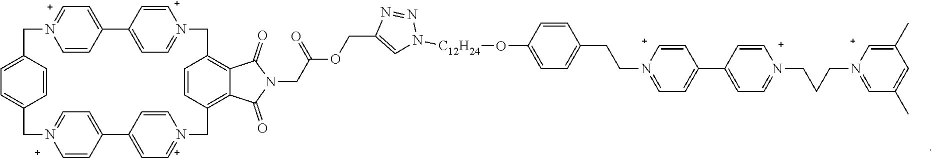

In some embodiments, the molecular-pump-containing monomers comprise two molecular pumps and a collecting chain joining the two molecular pumps. The daisy chain polymer may further comprise a multiplicity of macrocyclic monomers. The macrocyclic monomers may comprise two redox-active macrocyclic components and a chain joining the two redox-active macrocyclic components. In some embodiments, the redox-active macrocyclic component of the macrocyclic monomer is kinetically trapped on the collecting chain of the molecular-pump-containing monomer. In some embodiments, the redox-active macrocyclic component of the macrocyclic monomer is host-guest paired with the recognition site of the molecular-pump-containing monomer. In some embodiments, the redox-active macrocyclic component of one molecular-pump containing monomer is host-guest paired with the recognition site of another molecular-pump-containing monomer. In some embodiments, the recognition site comprises a viologen subunit. In some embodiments, the Coulombic barrier comprises a dimethylpyridinium. In some embodiments, the redox-active macrocyclic component comprises a cyclobis(paraquat-p-phenylene) (CBPQT) macrocycle. In some embodiments, the molecular-pump-containing monomers are

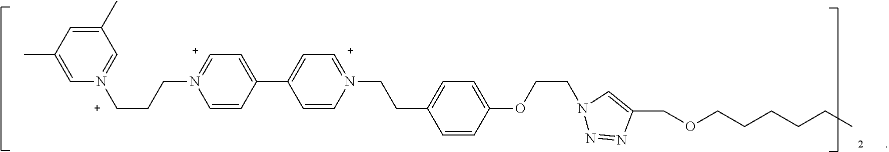

In some embodiments, the daisy chain polymer has a degree of polymerization of 3 or greater.

Another aspect of the technology is a composition for preparing a daisy chain polymer. The composition may comprise a plurality of any of the molecular-pump-containing monomers described herein. In some embodiments, the composition further comprises a plurality of any of the macrocyclic monomers described herein.

The daisy chain polymers described herein may be prepared with an energy ratchet mechanism. The method of preparing a daisy chain polymer may comprise reducing a plurality of molecular-pump-containing monomers with a reducing agent, thereby host-guest pairing a multiplicity of molecular-pump-containing monomers. The method may further comprise oxidizing the multiplicity of host-guest paired molecular-pump-containing monomers, thereby kinetically trapping the multiplicity of molecular-pump-containing monomers.

The daisy chain polymers described herein may depolymerized. The method for depolymerizing the daisy chain polymers may comprise oxidizing a multiplicity of host-guest paired molecular-pump-containing monomers with an oxidizing agent, thereby detreading the multiplicity of molecular-pump-containing monomers. The method may further comprise reducing a multiplicity of kinetically trapped molecular-pump-containing monomers to prepare the multiplicity of host-guest paired molecular-pump-containing monomers.

These and other aspects of the invention will be further described herein.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIGS. 1A-1C. FIG. 1A shows a graphical representation of the energy ratchet mechanism as it relates to the operation of the molecular pump with corresponding energy profiles. FIG. 1B shows a graphical representation of molecular pump-induced polymerization under redox control, using a self-complementary monomer. FIG. 1C shows the structural formulas of the self-complementary monomer M·7PF₆ and the dimeric dumbbell DB·6PF₆.

FIGS. 2A-2E. FIG. 2A shows a graphical representation of the synthesis of [3]R¹⁴⁺ using one redox cycle. FIG. 2B shows a ¹H NMR Spectrum of CBPQT⁴⁺. FIG. 2C shows a ¹H NMR Spectrum of crude [3]R¹⁴⁺, obtained after one redox cycle. FIG. 2D shows a ¹H NMR Spectrum of purified [3]R¹⁴⁺ with the numbers denoting the assignments of the resonances. FIG. 2E shows a ¹H NMR Spectrum of DB⁶⁺ with the numbers denoting the assignments of the resonances.

FIGS. 3A-3E. FIG. 3A shows a graphical representation for the redox-controlled polymerization and depolymerization. FIG. 3B shows a ¹H NMR Spectrum of M⁷⁺. FIG. 3C shows a ¹H NMR Spectrum of the polymerized crude product obtained by adding Ag₂SO₄ in three portions consecutively to the 25 mM MeCN solution of M^{4+3·}, leading to relatively high intensity integrations (˜32%) of the resonances (marked with triangles) for the protons associated the unbounded CBPQT⁴⁺ rings and dumbbells. FIG. 3D shows a ¹H NMR Spectrum of the polymerized crude product obtained by adding excess of Ag₂SO₄ in one portion to the 25 mM MeCN solution of M^{4+3·}, leading to relatively low intensity integrations (˜9%) of the resonances (marked with triangles) for the protons associated with the unbounded CBPQT⁴⁺ rings and dumbbells. FIG. 3E shows a ¹H NMR Spectrum of the recovered M⁷⁺ obtained by reducing the polymerized crude product to M^{4+3·} and then oxidizing it under ambient conditions.

FIG. 4 shows a graphical representation for the possible mechanism of dissociation under slow oxidation conditions and the corresponding energy profiles. When one electron is taken from the trisradical tricationic complex, the resulting bisradical tetracationic complex will dissociate, not only because its association is decreased dramatically, but also because the electrostatic barrier to dethreading of the ring—either in its CBPQT^{2(·+)} or CBPQT^{·3+} state—is much lower than the fully oxidized state.

FIGS. 5A-5B. FIG. 5A shows a stacked Vis/NIR spectra obtained by titrating 5^{·2+} into a solution of CBPQT^{2(·+)} (0.25 mM in MeCN). FIG. 5B shows a binding isotherm simulation. Optical length: 2 mm.

FIG. 6 shows a ¹H NMR Spectra (500 MHz/CD₃CN/298 K) of [3]R·14PF₆ at 25° C. (top), 70° C. (middle), and after heating for 16 h at 70° C. (bottom).

FIG. 7 shows a diffusion ordered NMR Spectrum (500 MHz/CD₃CN/298 K) of the daisy chain polymer.

FIG. 8 shows a diffusion ordered NMR Spectrum (500 MHz/CD₃CN/298 K) of M·7PF₆.

### DESCRIPTION OF THE INVENTION

Herein we disclose a new protocol to synthesis daisy chain polymers employing an energy ratchet mechanism. Daisy chain polymers are a subclass of mechanically bonded polymers or as well as a subclass of polyrotaxanes. Daisy chain polymers may be prepared by harnessing artificial molecular pumps to controllably deliver rings by dint of redox-driven processes. This programmable strategy leads to the precise incorporation of macrocyclic rings onto collecting chains to give rise to mechanically bonded polymers with control over the numbers of mechanical bonds. Importantly, the formation of the mechanically bonded polymers can be independent of the nature of a chosen threading component or collecting chain because of the high operational reliability of molecular pumps.

As demonstrated in the Examples that follow, molecular-pump containing monomers were designed and used to prepare mechanically bonded polymers. The strategy for synthesizing daisy chain polymers utilizing monomers based on molecular pumps operated away-from-equilibrium. The molecular pumps serve as both recognition sites and Coulombic barriers, rather than steric ones. Under different redox states, the molecular pumps enable polymerization as well as depolymerization under redox stimuli.

A “recognition site” or “RS” means a part of the molecular pump at which a macrocyclic component of a rotaxane prefers to locate. A recognition site immobilizes a macrocyclic component with host-guest noncovalent interactions typical of supramolecular chemistry. Suitably, the recognition site may be comprised of radical, ionic, polar, or hydrophobic groups, including any combination thereof. In some embodiments, the recognition site allows for radical pairing with the macrocyclic component. In some embodiments, the RS is a viologen subunit. A “viologen subunit” (V) means a subunit that is substituted or unsubstituted 4,4′-bipyridine, such as C₁₀H₈N₂. Viologens include 4,4′-bipyridinium (BIPY) subunits.

A “Coulombic barrier” or “CB” means a part of the molecular pump that presents a thermodynamic or kinetic barrier to a macrocyclic component. The thermodynamic or kinetic barrier may depends strongly on the redox state of the Coulombic barrier. Suitably the CB may be a chemical group capable of being in an ionic and/or radical redox state. Exemplary CBs include substituted or unsubstituted heteroaryls, such as 2,6-dimethylpyridinium (PY) or 3,5-dimethylpyridinium.

The recognition site and Columbic barrier may be joined by a linking subunit. In some embodiments, the linking subunit is a trismethylene subunit or bismethylene subunit, but other linking subunits may also be selected. The linking subunit may be selected to alter the association constant Kₐ of radical recognition pairs.

A “rotaxane” means a molecular assembly comprising at least one molecular component with a linear section threaded through at least one macrocyclic component of another or the same molecular component, and having end-groups capable of preventing dethreading of the macrocyclic component via thermodynamic or kinetic trapping of the macrocyclic component.

A “polyrotaxane” means a polymer composed of macromolecules that are macromolecular rotaxanes. When describing a rotaxane, the number n indicates the total number of independent components of the rotaxane, i.e., n=t+m where t is the total number of threading components and m is the total number of macrocyclic components.

A “macrocyclic component” or “MC” means a molecule that has at least one ring (cycle) large enough to allow it to be threaded onto a linear subchain of another molecule. Macrocyclic components include cyclobis(paraquat-p-phenylene) (CBPQT) in any of its possible redox states such as CBPQT⁴⁺, CBPQT^{·3+}, or CBPQT^{2(·+)}.

A “threading component” or “TC” means a molecule comprising at least one molecular pump and at least one collecting chain (CC) onto which at least one macrocyclic component is collected. In some embodiments, the TC component comprises one molecular pump. In other embodiments, the TC comprises two molecular pumps.

A “collecting chain” or “CC” is a linear subchain. The CC may be suitably selected from a number of different groups, including alkyl or polyether chains (e.g., polyethylene glycol chains). When the collecting chain is long enough, rotaxanes are highly stable at elevated temperatures over prolonged period of time. For example, when the collecting chain is longer than 11 atoms long, i.e., longer than —CH₁₁H₂₂—, a [2]rotaxane may be highly stable even at 80° C. for hours or longer. A long collecting chain may also make formation of cyclic oligomers unfavorable in the reduced state.

In some embodiments, the collecting chain may also include an aryl group (e.g., a phenylene subunit) and, optionally, a linking subunit (e.g., a trismethylene subunit or bismethylene subunit) between the aryl group and the molecular pump. The aryl group and linking subunit, if present, may be selected to alter the association constant Kₐ of radical recognition pairs.

In the Examples that follow, the preparation of an AB-type and an AA-type molecular-pump-containing monomers is disclosed. An AB-type molecular-pump-containing monomer comprises a molecular pump (A), a redox-active macrocyclic component (B), and a collecting chain joining the molecular pump and the redox-active macrocyclic component. AB-type monomers may be used to prepare homopolymers where the molecular pump of one monomer is capable of treading through the redox-active macrocyclic component of another monomer.

An AA-type molecular-pump-containing monomer comprises two molecular pumps (A) and a collecting chain joining the two molecular pump. AA-type monomers may be used to prepare copolymers with BB-type monomers, or macrocyclic monomers, where BB-type monomers comprises two redox-active macrocyclic components (B) and a chain joining the two redox-active macrocyclic components. When AA- and BB-type monomers are used, one of the molecular pumps of the AA-type monomer is capable of treading through the redox-active macrocyclic component of a first BB-type monomer and the other molecular pump of the AA-type monomer is capable of treading through the redox-active macrocyclic component of a second BB-type monomer.

As illustrated in the examples, the daisy chain polymer may contain cyclobis(paraquat p-phenylene) (CBPQT⁴⁺) rings and molecular pump units composed by a pyridium (PY⁺) unit and a bipiridinium (BIPY²⁺) units.

The monomers can undergo dynamic and reversible supramolecular polymerization at reduced conditions because of host-guest pairing interactions, such as radical pairing interactions, between macrocyclic components and the molecular pumps. Upon fast oxidation, the supramolecular polymers can be converted into kinetically trapped daisy chain polymers on account of energy ratchet mechanism. The daisy chain polymers can be switched back to the supramolecular polymer reversibly by reduction, and thus be depolymerized into the monomers using a slow-oxidation protocol to fully recover the monomers.

Compositions comprising a plurality of molecular-pump-containing monomers as described herein may be used to prepare daisy chain polymers comprising a multiplicity of kinetically trapped or host-guest paired molecular-pump-containing monomers. When AA-type molecular-pump-containing monomers, the composition may further comprise a multiplicity BB-type macrocylic monomers to allow for polymerization. In addition, the methods disclosed herein allow for depolymerization of daisy chain polymers into their respective monomers.

As used herein, “multiplicity” is used to denote the degree of polymerization (DP). Suitably, DP is at least 3 but may be more depending on the association constant for the monomers and polymerization conditions employed. In some embodiments, the DP is at least 4, 5, 6, 7, 8, 9, 10, 11, or more. “Plurality” is used to denote the amount of monomers in a solution or other composition. Suitably, the amount of monomers in a composition may be measured on a mole scale (such as pmol, nmol, μmol, mmol, mol, or more), molar scale (such as pM, nM, μM, mM, M, or more), or gram scale (such as pg, ng, μg, mg, g, or more).

The assembly of a kinetically trapped daisy chain polymer under redox control has been achieved with a self-complementary monomer using an energy ratchet mechanism. In the Examples, the monomer is composed of a molecular pump at one end and a cyclobis(paraquat-p-phenylene) (CBPQT⁴⁺) ring at the other end, which are linked together by a long collecting chain. When the monomer is reduced to its radical state, it self-assembles into a supramolecular daisy chain polymer on account of radical-pairing interactions between a bipyridinium radical cation (BIPY^{·+}) on the pump head and the CBPQT^{2(·+)} ring. When excess of Ag₂SO₄ is added quickly to the solution in order to oxidize the BIPY^{·+} units to BIPY²⁺ dications, the CBPQT⁴⁺ rings are forced to thread onto the collecting chains, forming an out-of-equilibrium, kinetically trapped daisy chain polymer. This polymer can be switched reversibly back to the supramolecular polymer by reduction, followed by depolymerization to afford the monomer as a result of slow oxidation under ambient conditions. The present disclosure allows for preparation of out-of-equilibrium self-assembly systems and opens up new opportunities for the synthesis of mechanically bonded polymers.

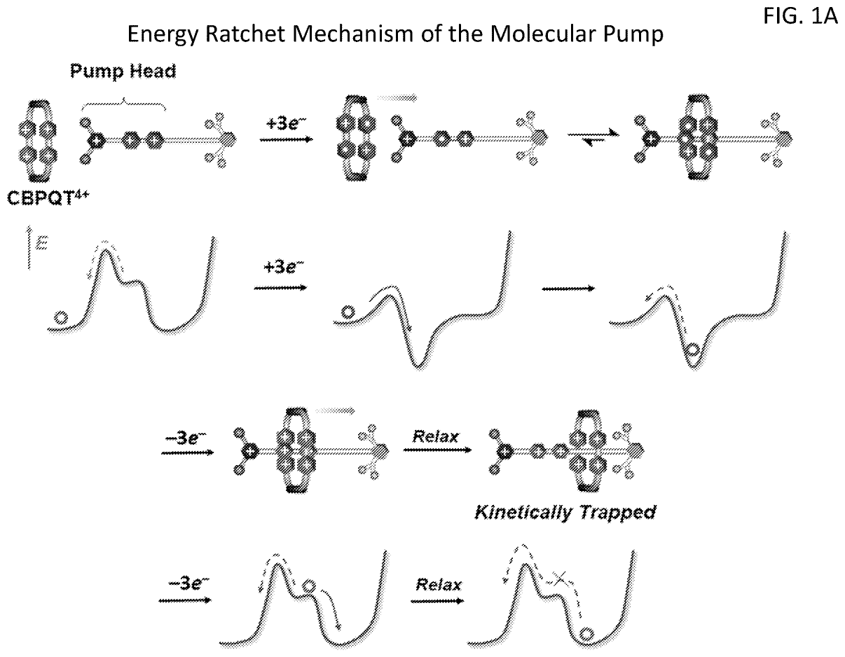

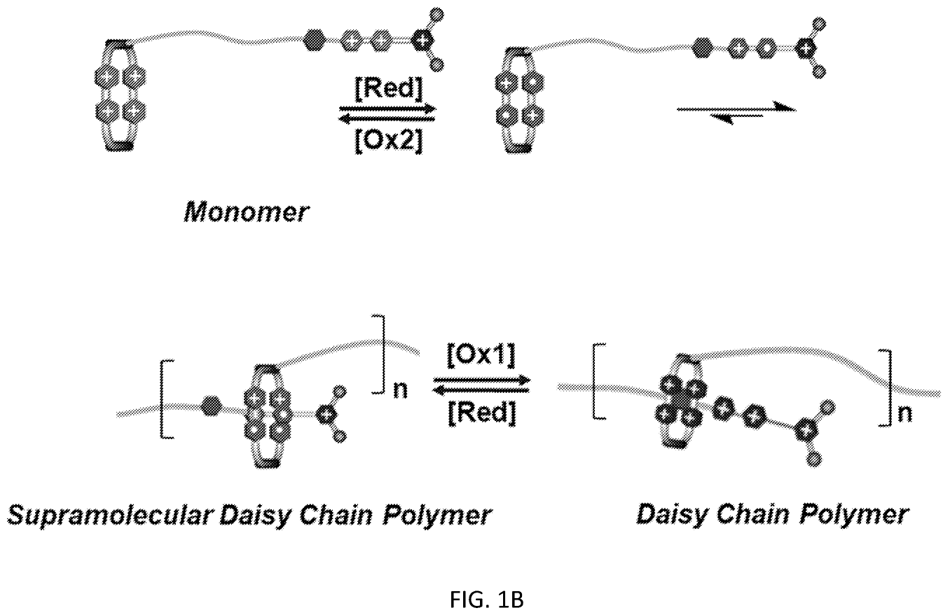

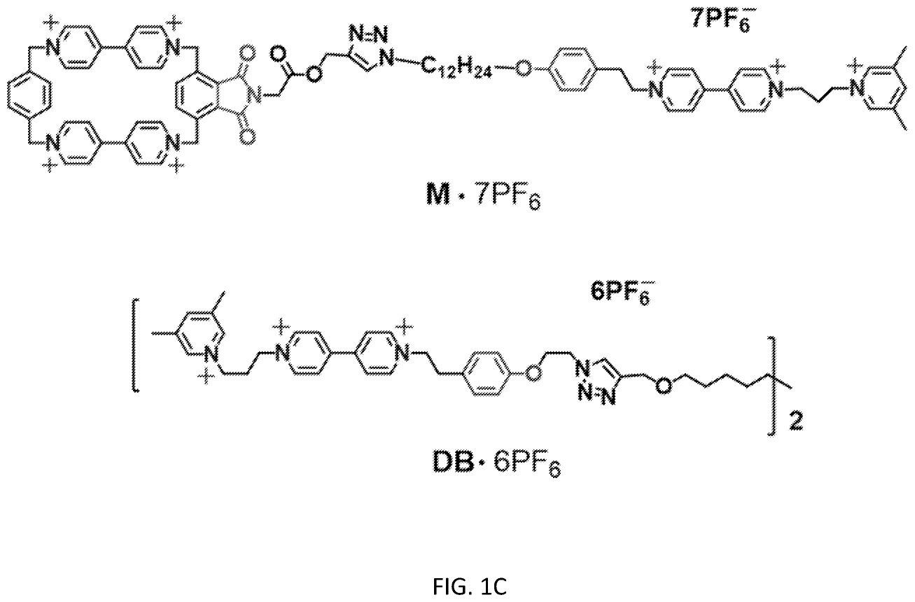

FIG. 1A illustrates the structure of a threading component that comprises a “pump head” or molecular pump. The molecular pump may be composed of a 3,5-dimethylpyridinium (Py⁺) unit which acts as a Coulombic barrier and a bipyridinium (BIPY²⁺) unit which acts as the recognition site. Suitably, the threading component may also comprise a collecting chain and, optionally, a stopper. When a reducing agent is added to the threading component in a solvent, such as MeCN, in the presence of CBPQT⁴⁺, all the BIPY²⁺ units are reduced and radical interactions comes into play with the formation of a trisradical tricationic complex. The addition of an oxidizing agent restores the positive charges to the three bipyridium units, enforcing the CBPQT⁴⁺ ring to move towards the collecting chain, rather than depart from the Py⁺ end because of Coulombic repulsions, regardless of there not being any strong binding site on the collecting chain. Notably, the kinetically stability or life-time of the resulting metastable [2]rotaxane can be tuned by varying the length of the collecting chain and/or the number of methylene groups in the linker between the BIPY²⁺ and Py⁺ units. When the collecting chain is long enough, i.e., longer than —C₁₁H₂₂—, the metastable [2]rotaxane is highly stable even at 80° C., rendering it a rotaxane rather than a pseudorotaxane. Overall, one mechanical bond is formed, after one redox cycle, leading to a [2]rotaxane using the molecular pump prototype¹⁰

The concept of molecular pumping illustrated in FIG. 1A allows for polymer synthesis. FIG. 1B illustrates a self-complementary monomer that incorporates a macrocyclic component, such as a CBPQT⁴⁺ ring, covalently to a molecular pump with a collecting chain, affording a self-complementary monomer. Under reducing conditions, the monomer self-assembles into a supramolecular daisy chain polymer on account of radical-pairing interactions. The polymerization is dynamic and concentration/temperature dependent under thermodynamic control. On oxidation, mechanical bonds are formed since the CBPQT⁴⁺ rings will thread onto the collecting chains at the behest of the pumping mechanism, leading to the formation of a kinetically trapped daisy chain polymer. One notable feature of this daisy chain polymer is the fact that it can be switched back-and-forth between a mechanically bonded daisy chain polymer and a dynamic supramolecular polymer under redox control. Such a property, according to our knowledge, has not been reported in the literature.

The average degree of polymerization (DP) is related to the association constant (Kₐ) of the radical recognition pairs and the monomer concentration ([M]₀), i.e., DP≈(Kₐ[M]₀)^{1/2}. Portions of the molecular pump or collecting chain may be selected to achieve a higher association constant. A linking unit between the recognition site and the Coulombic barrier is be selected to lead to a higher binding constant.

FIG. 1C illustrates two exemplary molecular-pump-containing monomers. M·7PF₆ is an AB-type monomer and DB·6PF₆ is an AA-type monomer. Each of these monomers comprise a trismethylene unit as the linker between the Py⁺ and BIPY²⁺. Each of these monomers also comprise a para-phenylene unit in the collecting chain with a bismethylene linker to the BIPY²⁺ unit. Such a collecting chain may enhance the binding constant in the reduced state and increases the kinetic stability of the rotaxane in its oxidized state since it can serve as a binding site, although weak, for a macrocyclic component, such as a CBPQT⁴⁺ ring. Moreover, a long collecting chain chosen makes the formation of cyclic oligomers unfavorable in the reduced states as well as ensuring the kinetic stability of the daisy chain polymers.

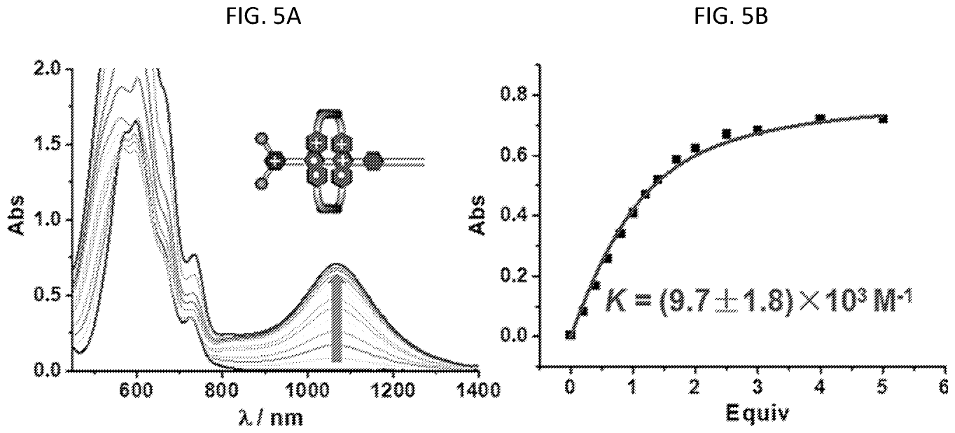

The dimeric dumbbell DB·6PF₆ and monomer M·7PF₆ were synthesized and fully characterized by ¹H NMR and ¹H-¹H COSY NMR spectroscopies, as well as by high resolution ESI-mass spectrometry. See Examples. The association constant (Kₐ) between the molecular pump precursor and CBPQT⁴⁺ under reducing condition was determined by Vis/NIR titration and the Kₐ value was found to be (9.7±1.8)×10³ M⁻¹ (FIGS. 5A-5B).

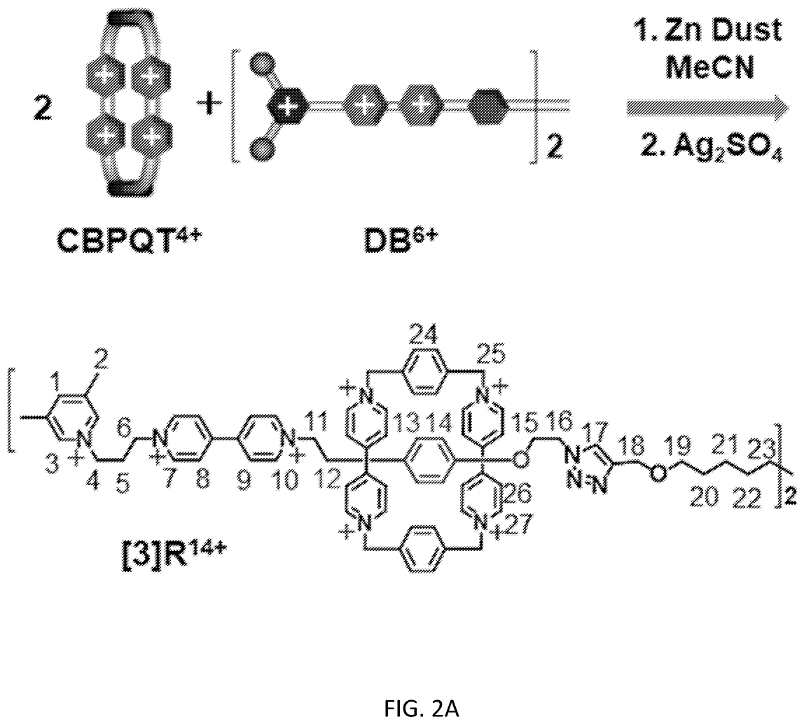

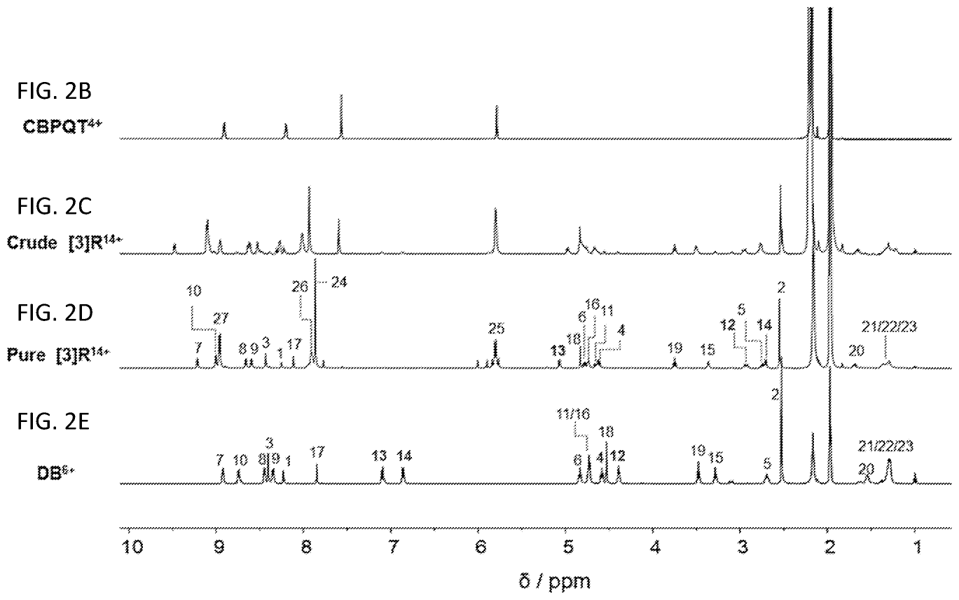

The pumping test was carried out using, in the first instance, DB·6PF₆ and CBPQT·4PF₆. 3.0 Molar equiv of CBPQT·4PF₆ was mixed with DB·6PF₆ in MeCN at a concentration of 10 mM in a N₂-filled glovebox. Excess of Zn dust was added to the solution to reduce the BIPY²⁺ units to BIPY^{·+} radical cations. After stirring at room temp for 10 min, the solution turned a deep purple color, which is characteristic¹⁶ of a BIPY^{·+⊂}CBPQT^{2·+} interaction. Zn Dust was removed by filtration, and excess of Ag₂SO₄ was added as a solid in one portion to the MeCN solution with stirring, producing a yellow-colored solution. A crude ¹H NMR spectrum, which was recorded and analyzed, indicated (FIG. 2C) the formation of a [3]rotaxane—namely [3]R¹⁴⁺. The crude products were purified by reverse-phase column chromatography, affording pure [3]R·14PF₆ in 74% yield. By comparing the ¹H NMR spectra of DB·6PF₆ (FIG. 2D) and pure [3]R·14PF₆ (FIG. 2C), one significant observation can be made: the resonances for the two protons—H-13 and H-14 in FIG. 2A—on the para-phenylene rings of the dumbbell shift from 7.10 and 6.87 ppm to 5.07 and 2.71 ppm, respectively. Meanwhile, the signals for protons—H-12 in FIG. 2A—associated with the methylene units adjacent to the para-phenylene rings are also shifted significantly upfield. These dramatic upfield shifts indicate that the CBPQT⁴⁺ rings are encircling the para-phenylene units on the dumbbell as a result of weak donor-acceptor interactions, indicating the formation of [3]R¹⁴⁺.

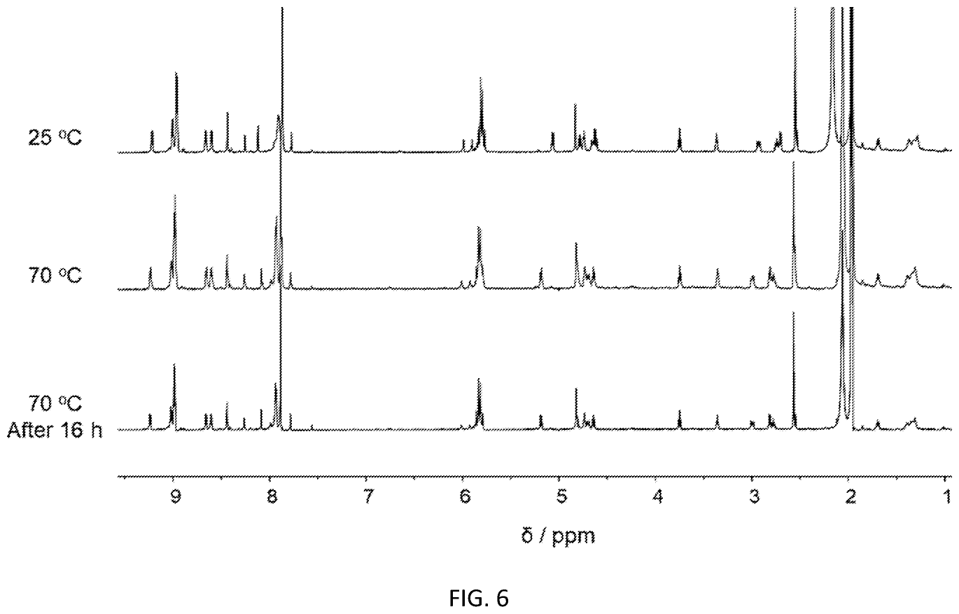

The stability of [3]R·14PF₆ was checked by recording its ¹H NMR spectrum at 70° C., only to find out that it displayed (FIG. 6) no observable change after 16 h. This observation indicates that the rotaxane is very stable on account of the high electrostatic barriers to dethreading at the two pump heads.

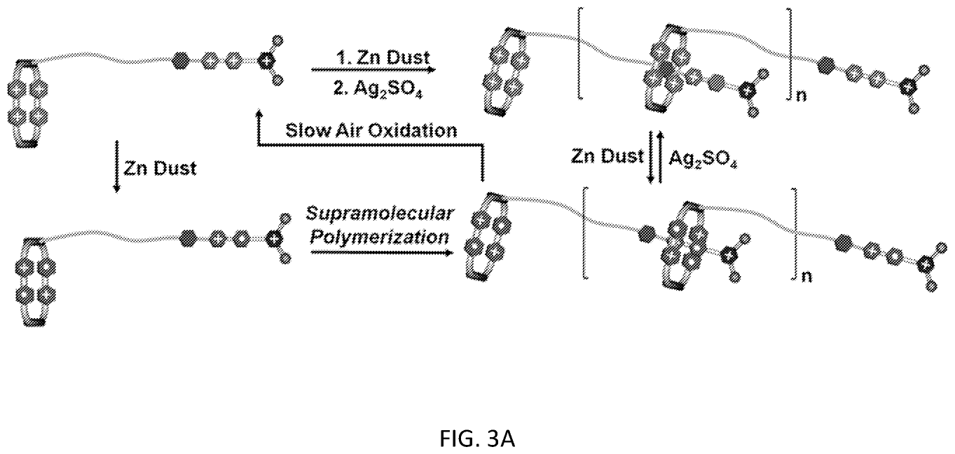

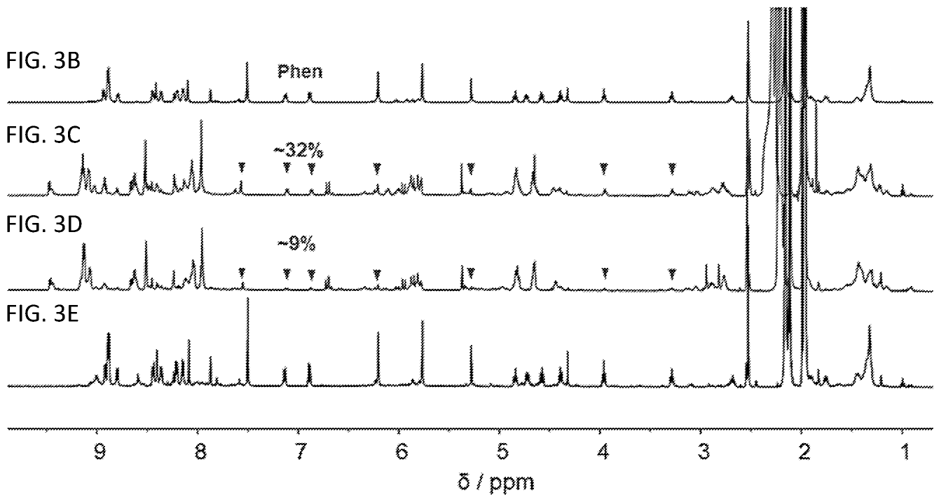

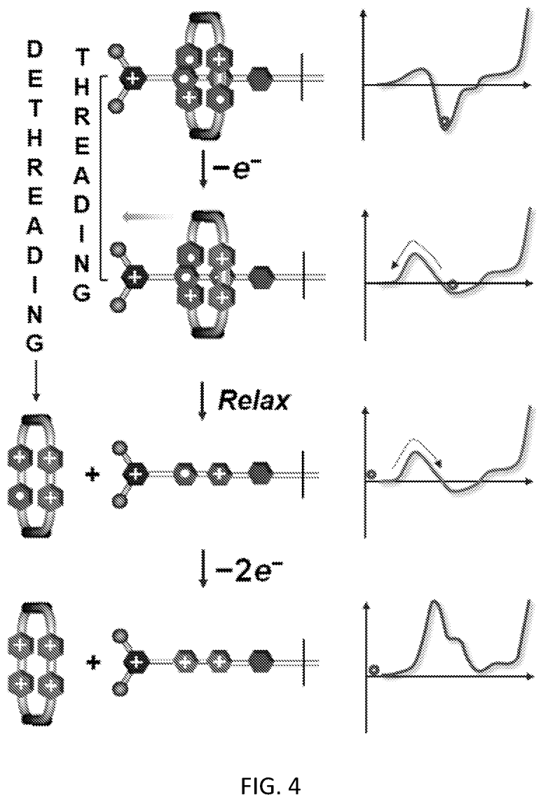

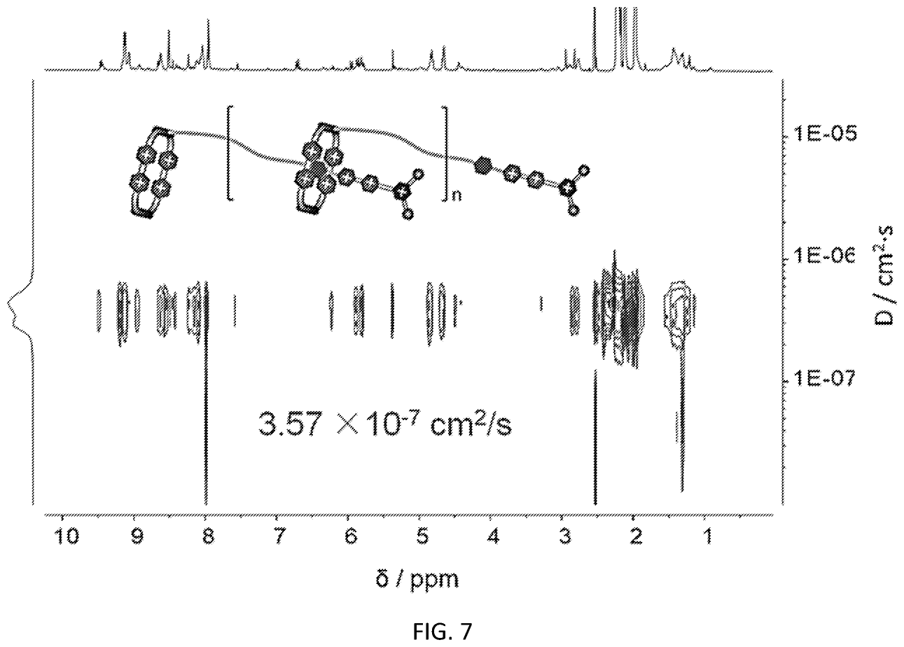

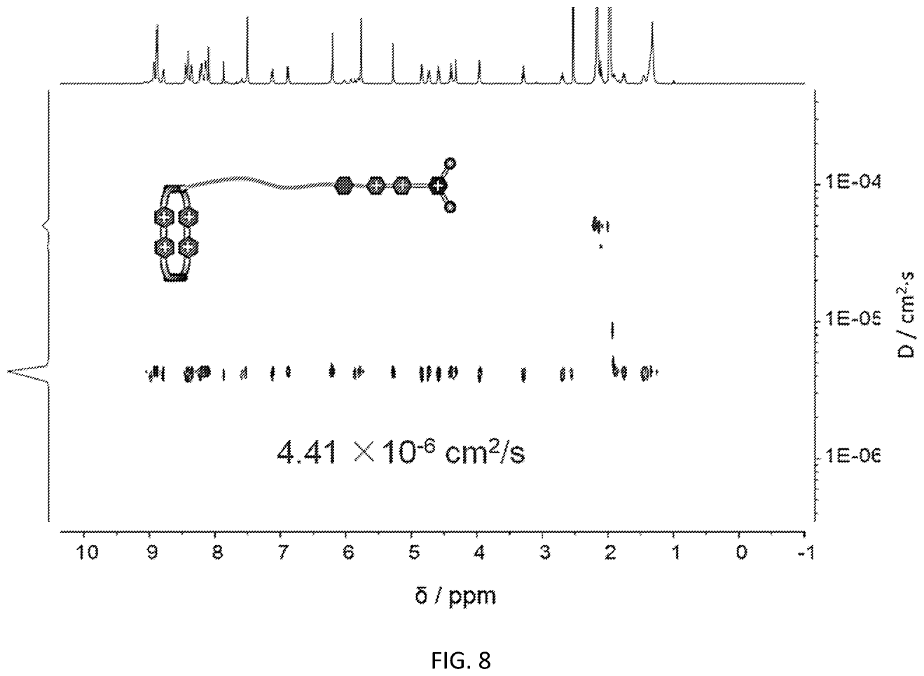

The polymerization of M·7PF₆ was conducted (FIG. 3A) using an analogous procedure. The 25 mM MeCN solution of M·7PF₆ was reduced with an excess of Zn dust in a N₂-filled glovebox. After filtration, excess of Ag₂SO₄ was added in one portion to the purple colored solution while stirring, producing a yellow-colored solution. The crude product displayed (FIG. 3D) a more complicate ¹H NMR spectrum with broader signals compared to that (FIG. 3B) of M·7PF₆, while some of the resonances are quite similar in chemical shifts to those observed for [3]R¹⁴⁺, indicating the formation of rotaxanes. The important characteristic peaks associated with rotaxane formation are the resonances for the four protons on the para-phenylene units of the collecting chain, which were shifted dramatically upfield on account of the CBPQT⁴⁺ rings residing on the para-phenylene units. Accordingly, the remaining para-phenylene proton signals around 7.10 and 6.87 ppm are associated with end groups since they represent the free collecting chains that are not encircled by CBPQT⁴⁺ rings. From the crude ¹H NMR spectrum, we note (FIG. 3D) that the integrations of these two peaks for the free para-phenylene units decrease by ˜9%. Correspondingly, a set of signals were also observed with ˜9% integrated intensity, which can be assigned to the protons on the free collecting chains or free CBPQT⁴⁺ rings. Taken together, we conclude that there are ˜9% unbounded collecting chains and CBPQT⁴⁺ rings existing in the crude product, indicating an average DP¹⁹ of around 11, which is lower than the theoretically predicted DP of 15.4 deduced from the Kₐ value of (9.7±1.8)×10³ M⁻¹ at a concentration of 25 mM. The highly charged polyelectrolyte nature of the daisy chain polymer renders it difficult to conduct size exclusion chromatography or ESI-MS characterizations. Consequently, we are unable to obtain polydispersity information for this polymer. The diffusion-ordered NMR spectrum (FIG. 7) of the crude product indicates a diffusion coefficient of 3.57×10⁻⁷ cm²/s, a value which is one order of magnitude lower (FIG. 8) than that (4.41×10⁻⁶ cm²/s) of M·7PF₆, supporting a much larger molecular size and weight for the crude product than for that of M·7PF₆.

The lower DP compared with the theoretical value can be ascribed to (i) the fact that the actual Kₐ value, associated with the radical recognition pairs in the case of self-complementary monomer M·7PF₆ may be lower than that observed in the control experiment. (ii) The pumping efficiency of M·7PF₆ is unlikely to be 100%, leading to a decrease in the DP. In fact, we observed that the manner in which we conducted the oxidation is important as far as the polymerization is concerned. When the oxidizing agent Ag₂SO₄ was added in three portions consecutively rather than in one portion quickly, the resulting products showed a much lower DP employing the same concentration of M·7PF₆. The crude ¹H NMR spectrum displays (FIG. 3C) a very similar resonance pattern as the crude product obtained by adding one portion of Ag₂SO₄ all at once. The integration of signals representing the unbounded collecting chains or CBPQT⁴⁺ rings was found to be ˜32%. This higher percentage indicates that the crude product contains shorter oligomers with an average DP of ca. 3, which is much lower than the DP (˜11) obtained when Ag₂SO₄ is added in one portion. This result indicates that the DP can be controlled by the manner in which the oxidizing agent is added to the supramolecular polymer solution.

Depolymerization of the daisy chain polymer may be accomplished in a convenient way. Excess of Zn dust was added to the MeCN solution of the daisy chain polymer to reduce it back to its radical form, i.e., the supramolecular polymer. After filtration, the solution was placed under ambient conditions and was slowly oxidized by air diffusion. When the color of the solution turned light yellow, a crude ¹H NMR spectrum was recorded and found (FIG. 3E) to correspond to almost pure M·7PF₆. It follows that, the daisy chain polymer can be easily depolymerized and the monomer can also be recycled in one single redox cycle.

The slow-oxidation induced dissociation is understandable since the oxidation of the trisradical tricationic complex involves the loss of three electrons. When the first electron of the trisradical tricationic complex is extracted by the oxidant, a bisradical tetracationic complex (FIG. 4) is formed. The association of this complex, however, is significantly decreased^{14,16} compared to the trisradical tricationic complex. Meanwhile, the barrier to dethreading of the rings—either in their CBPQT^{2(·+)} or CBPQT^{·3+} states²⁰—is much lower (FIG. 4) than for the fully oxidized state. The diradical tetracationic complex can be either BIPY^{·+⊂}CBPQT^{·3+} or BIPY^{2+⊂}CBPQT^{2(·+)} in which one electron is taken from the trisradical tricationic complex BIPY^{·+⊂}CBPQT^{2(·+)}. These two forms, however, will be under rapid equilibrium because of the fast electron exchange between all the BIPY^{·+}/BIPY²⁺ units in solution. As a result, no matter the CBPQT ring is in the CBPQT^{2(·+)} or CBPQT^{·3+} form, dethreading of the ring will always happen if the relaxation time is long enough. Consequently, the dissociation can take place at this juncture, leading to the depolymerization of the daisy chain polymer. In general, if there is a long enough relaxation time during the oxidation process, the unidirectional pumping process does not happen and the out-of-equilibrium mechanically bonded structure will not be formed.

The controllable kinetic stability of the daisy chain polymers render them useful in life-time-controllable and recycle polymer materials. The polyelectrolyte nature of the polymers may also render them useful for preparation of membrane materials. There are a number of application for the polymers disclosed herein. The daisy chain polymer as useful in slide-ring gels and in the preparation of materials possess unique mechanical properties.

In summary, we have demonstrated that molecular pumping can be exploited in polymer synthesis, enabling the assembly of a daisy chain polymer out-of-equilibrium by supplying chemical energy in one redox cycle. Notably, this kinetically trapped, mechanically bonded polymer can be switched reversibly to the dynamic supramolecular polymer under reducing conditions. Hence, the polymer can be depolymerized into monomers by relaxing the kinetically trapped polymer to its thermodynamic stable state under redox control.

### Miscellaneous

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCES

(1) (a) Raymo, F. M.; Stoddart, J. F. Interlocked macromolecules. Chem. Rev. 1999, 99, 1643-1664. (b) Fang, L.; Olson, M. A.; Benítez, D.; Tkatchouk, E.; Goddard III, W. A.; Stoddart, J. F. Mechanically bonded macromolecules. Chem. Soc. Rev. 2012, 39, 17-29. (c) Mena-Hernando, S.; Pérez, E. M. Mechanically interlocked materials. Rotaxanes and catenanes beyond the small molecule. Chem. Soc. Rev. 2019, 48, 5016-5032.
(2) (a) Li, S.; Zheng, B.; Chen, J.; Dong, S.; Ma, Z.; Huang, F.; Gibson, H. W. A hyperbranched, rotaxane-type mechanically interlocked polymer. J. Poly. Sci. Poly. Chem. 2010, 48, 4067-4073. (b) Kohsaka, Y; Koyama, Y; Takata, T. Graft polyrotaxanes: A new class of graft copolymers with mobile graft chains. Angew. Chem. Int. Ed. 2011, 50, 10417-10420. (c) Aoki, D.; Uchida, S.; Takata, T. Mechanically linked block/graft copolymers: Effective synthesis via functional macromolecular [2] rotaxanes. ACS Macro Lett. 2014, 3, 324-328. (d) Wang, P.; Gao, Z.; Yuan, M.; Zhu, J.; Wang, F. Mechanically linked poly[2]rotaxanes constructed from the benzo-21-crown-7/secondary ammonium salt recognition motif. Poly. Chem. 2016, 7, 3664-3668. (e) Wu, Q.; Rauscher, P. M.; Lang, X.; Wojtecki, R. J.; de Pablo, J. J.; Hore, M. J.; Rowan, S. J. Poly[n]catenanes: Synthesis of molecular interlocked chains. Science, 2017, 358, 1434-1439. (f) Kwan, C. S.; Zhao, R.; Van Hove, M. A.; Cai, Z.; Leung, K. C. F. Higher-generation type III-B rotaxane dendrimers with controlling particle size in three-dimensional molecular switching. Nat. Commun. 2018, 9, 487. (g) Wang, X. Q.; Wang, W.; Li, W. J.; Chen, L. J.; Yao, R.; Yin, G. Q.; Wang, Y. X.; Zhang, Y.; Huang, J.; Tan, H.; Yu, Y Li, X.; Xu, L.; Yang, H.-B. Dual stimuli-responsive rotaxane-branched dendrimers with reversible dimension modulation. Nat. Commun. 2018, 9, 3190. (h) Rauscher, P. M.; Rowan, S. J.; de Pablo, J. J. Topological effects in isolated poly[n]catenanes: Molecular dynamics simulations and Rouse mode analysis. ACS Macro Lett. 2018, 7, 938-943.
(3) (a) Harada, A.; Li, J.; Kamachi, M. The molecular necklace: A rotaxane containing many threaded α-cyclodextrins. Nature, 1992, 356, 325-327. (b) Cacialli, F.; Wilson, J. S.; Michels, J. J.; Daniel, C.; Silva, C.; Friend, R. H.; Severin, N.; Samorí, P.; Rabe, J. P.; O′Connell, M. J.; Taylor, P. N. Cyclodextrin-threaded conjugated polyrotaxanes as insulated molecular wires with reduced interstrand interactions. Nat. Mat. 2002, 1, 160-164. (c) Wenz, G.; Han, B. H.; Müller, A. Cyclodextrin rotaxanes and polyrotaxanes. Chem. Rev. 2006, 106, 782-817; (d) Momc̆ilović, N.; Clark, P. G.; Boydston, A. J. Grubbs, R. H. One-pot synthesis of polyrotaxanes via acyclic diene metathesis polymerization of supramolecular monomers. J. Am. Chem. Soc. 2011, 133, 19087-19089. (d) De Bo, G.; De Winter, J.; Gerbaux, P.; Fustin, C. A. Rotaxane-based mechanically linked block copolymers. Angew. Chem. Int. Ed. 2011, 50, 9093-9096.
(4) (a) Okumura, Y; Ito, K. The polyrotaxane gel: A topological gel by figure-of-eight cross-links. Adv. Mater. 2001, 13, 485-487. (b) Ito, K. Slide-ring materials using topological supramolecular architecture. Curr. Opin. Solid State Mater. Sci. 2010, 14, 28-34. (c) Nakahata, M.; Mori, S.; Takashima, Y.; Yamaguchi, H.; Harada, A. Self-healing materials formed by cross-linked polyrotaxanes with reversible bonds. Chem, 2016, 1, 766-775. (d) Gotoh, H.; Liu, C.; Imran, A. B.; Hara, M.; Seki, T.; Mayumi, K.; Ito, K.; Takeoka, Y. Optically transparent, high-toughness elastomer using a polyrotaxane cross-linker as a molecular pulley. Sci. Adv. 2018, 4, eaat7629.
(5) (a) Choi, S.; Kwon, T. W.; Coskun, A.; Choi, J. W. Highly elastic binders integrating polyrotaxanes for silicon microparticle anodes in lithium ion batteries. Science, 2017, 357, 279-283. (b) Yoo, D. J.; Elabd, A.; Choi, S.; Cho, Y; Kim, J.; Lee, S. J.; Choi, S. H.; Kwon, T. W.; Char, K.; Kim, K. J.; Coskun, A. Highly elastic polyrotaxane binders for mechanically stable lithium hosts in lithium-metal batteries. Adv. Mater. 2019, 31, 1901645.
(6) (a) Moon, C.; Kwon, Y. M.; Lee, W. K.; Park, Y. J.; Yang, V. C. In vitro assessment of a novel polyrotaxane-based drug delivery system integrated with a cell-penetrating peptide. J Control Release 2007, 124, 43-50. (b) Yu, G.; Yang, Z.; Fu, X.; Yung, B. C.; Yang, J.; Mao, Z.; Shao, L.; Hua, B.; Liu, Y; Zhang, F.; Fan, Q. Polyrotaxane-based supramolecular theranostics. Nat. Commun. 2018, 9, 766.
(7) (a) Zhang, W.; Dichtel, W. R.; Stieg, A. Z.; Benitez, D.; Gimzewski, J. K.; Heath, J. R.; Stoddart, J. F. Folding of a donor-acceptor polyrotaxane by using noncovalent bonding interactions. Proc. Natl. Acad. Sci. 2008, 105, 6514-6519. (b) Zhang, W.; DeIonno, E.; Dichtel, W. R.; Fang, L.; Trabolsi, A.; Olsen, J. C.; Benitez, D.; Heath, J. R. Stoddart, J. F. A solid-state switch containing an electrochemically switchable bistable poly[n]rotaxane, J. Mater. Chem. 2011, 21, 1487-1495.
(8) (a) Zhang, M.; Li, S.; Dong, S.; Chen, J.; Zheng, B.; Huang, F. Preparation of a daisy chain via threading-followed-by-polymerization. Macromolecules, 2011, 44, 9629-9634. (b) Shi, Y.; Yang, Z.; Liu, H.; Li, Z.; Tian, Y; Wang, F. Mechanically linked poly[2]rotaxaties constructed via the hierarchical self-assembly strategy. ACS Macro Lett. 2015, 4, 6-10. (c) Tan, C. S. Y.; Liu, J.; Groombridge, A. S.; Barrow, S. J.; Dreiss, C. A.; Scherman, O. A. Controlling spatiotemporal mechanics of supramolecular hydrogel networks with highly branched cucurbit[8]uril polyrotaxanes. Adv. Funct. Mater. 2018, 28, 1702994.
(9) (a) Iwaso, K.; Takashima, Y; Harada, A. Fast response dry-type artificial molecular muscles with [c2]daisy chains. Nat. Chem. 2016, 8, 625-632. (b) Goujon, A.; Lang, T.; Mariani, G.; Moulin, E.; Fuks, G.; Raya, J.; Buhler, E.; Giuseppone, N. Bistable [c2]daisy chain rotaxanes as reversible muscle-like actuators in mechanically active gels. J. Am. Chem. Soc. 2017, 139, 14825-14828. (c) Goujon, A.; Moulin, E.; Fuks, G.; Giuseppone, N. [c2]Daisy chain rotaxanes as molecular muscles. CCS Chemistry, 2019, 1, 83-96.
(10) Cheng, C.; McGonigal, P. R.; Liu, W. G.; Li, H.; Vermeulen, N. A.; Ke, C.; Frasconi, M.; Stern, C. L.; Goddard III, W. A.; Stoddart, J. F. Energetically demanding transport in a supramolecular assembly. J. Am. Chem. Soc. 2014, 136, 14702-14705.
(11) (a) Hernández, J. V; Kay, E. R.; Leigh, D. A. A reversible synthetic rotary molecular motor. Science, 2004, 306, 1532-1537. (b) Baroncini, M.; Silvi, S.; Venturi, M.; Credi, A. Photoactivated directionally controlled transit of a non-symmetric molecular axle through a macrocycle. Angew. Chem. Inter. Ed. 2012, 51, 4223-4226. (c) Ragazzon, G.; Baroncini, M.; Silvi, S.; Venturi, M.; Credi, A. Light-powered autonomous and directional molecular motion of a dissipative self-assembling system. Nat. Nanotechnol. 2015, 10, 70-75. (d) Kay, E. R.; Leigh, D. A. Rise of the molecular machines. Angew. Chem. Inter. Ed. 2015, 54, 10080-10088. (e) Kassem, S.; van Leeuwen, T.; Lubbe, A. S.; Wilson, M. R.; Feringa, B. L.; Leigh, D. A. Artificial molecular motors. Chem. Soc. Rev. 2017, 46, 2592-2621.
(12) Ashton, P. R.; Baxter, I.; Fyfe, M. C.; Raymo, F. M.; Spencer, N.; Stoddart, J. F.; White, A. J.; Williams, D. J. Rotaxane or pseudorotaxane? That is the question! J. Am. Chem. Soc. 1998, 120, 2297-2307.
(13) Cheng, C.; McGonigal, P. R.; Schneebeli, S. T.; Li, H.; Vermeulen, N. A.; Ke, C.; Stoddart, J. F. An artificial molecular pump. Nature Nanotechnol. 2015, 10, 547-553.
(14) (a) Pezzato, C.; Nguyen, M. T.; Kim, D. J.; Anamimoghadam, O.; Mosca, L.; Stoddart, J. F. Controlling dual molecular pumps electrochemically. Angew. Chem. Int. Ed. 2018, 57, 9325-9329. (b) Qiu, Y.; Zhang, L.; Pezzato, C.; Feng, Y.; Li, W.; Nguyen, M. T.; Cheng, C.; Shen, D.; Guo, Q. H.; Shi, Y; Cai, K.; Alsubaie, F. A.; Astumian, R. D.; Stoddart, J. F. A molecular dual pump. J. Am. Chem. Soc. 2019, 141, 17472-17476.
(15) Trabolsi, A.; Khashab, N.; Fahrenbach, A. C.; Friedman, D. C.; Colvin, M. T.; Cotí, K. K.; Benítez, D.; Tkatchouk, E.; Olsen, J. C.; Belowich, M. E.; Carmielli, R. Radically enhanced molecular recognition. Nat. Chem. 2010, 2, 42-49.
(16) (a) Yang, L.; Tan, X.; Wang, Z.; Zhang, X. Supramolecular polymers: Historical development, preparation, characterization, and functions. Chem. Rev. 2015, 115, 7196-7239. (b) Price Jr T. L.; Gibson, H. W. Supramolecular pseudorotaxane polymers from biscryptands and bisparaquats. J. Am. Chem. Soc. 2018, 140, 4455-4465.
(17) Cheng, C.; Cheng, T.; Xiao, H.; Krzyaniak, M. D.; Wang, Y; McGonigal, P. R.; Frasconi, M.; Barnes, J. C.; Fahrenbach, A. C.; Wasielewski, M. R. Goddard III, W. A. Stoddart, J. F. Influence of constitution and charge on radical pairing interactions in trisradical tricationic complexes. J. Am. Chem. Soc. 2016, 138, 8288-8300.
(18) Scherman, O. A.; Ligthart, G. B. W. L.; Sijbesma, R. P.; Meijer, E. W. A selectivity-driven supramolecular polymerization of an AB monomer. Angew. Chem. Inter. Ed. 2006, 45, 2072-2076.
(19) The highly charged polyelectrolyte nature of the daisy chain polymer renders it difficult to conduct size exclusion chromatography or ESI-MS characterizations. Consequently, we are unable to obtain polydispersity information for this polymer.
(20) The diradical tetracationic complex can be either BIPY^{·+⊂}CBPQT^{·3+} or BIPY^{2+⊂}CBPQT^{2(·+)} in which one electron is taken from the trisradical tricationic complex BIPY^{·+⊂}CBPQT^{2(·+)}. These two forms, however, will be under rapid equilibrium because of the fast electron exchange between all the BIPY^{·+}/BIPY²⁺ units in solution. As a result, no matter the CBPQT ring is in the CBPQT^{2(·+)} or CBPQT^{·3+} form, dethreading of the ring will always happen if the relaxation time is long enough.
(21) (a) Boekhoven, J.; Brizard, A. M.; Kowlgi, K. N.; Koper, G. J.; Eelkema, R.; van Esch, J. H. Dissipative self-assembly of a molecular gelator by using a chemical fuel. Angew. Chem. Int. Ed. 2010, 49, 4825-4828. (b) van Rossum, S. A.; Tena-Solsona, M.; van Esch, J. H.; Eelkema, R.; Boekhoven, J. Dissipative out-of-equilibrium assembly of man-made supramolecular materials. Chem. Soc. Rev. 2017, 46, 5519-5535. (c) Tena-Solsona, M.; Rieβ, B.; Grötsch, R. K.; Löhrer, F. C.; Wanzke, C.; Käsdorf, B.; Bausch, A. R.; Müller-Buschbaum, P.; Lieleg, O.; Boekhoven, J. Non-equilibrium dissipative supramolecular materials with a tunable lifetime. Nat. Commun. 2017, 8, 15895. (d) Yin, Z.; Song, G.; Jiao, Y.; Zheng, P.; Xu, J. F. Zhang, X. Dissipative supramolecular polymerization powered by light. CCS Chemistry, 2019, 1, 335-342.

### EXAMPLES

### General Methods

All reagents were purchased from commercial suppliers and used without further purification. Compounds 2·2PF₆^{S1}, CBPQT·4PF₆^{S2}, CBPQT-CC·4PF₆^{S3}, 1,10-bis(prop-2-yn-1-yloxy)decane^{S4} were prepared according to literature procedures. Thin layer chromatography (TLC) was performed on silica gel 60 F254 (E Merck). Reverse-phase column chromatography (RediSep Rf Gold® Reversed-Phase C18), was carried out using CombiFlash® Automation Systems (Teledyne ISCO). UV/Vis Spectra were recorded at room temperature on a Shimadzu UV-3600 spectrophotometer. Nuclear magnetic resonance (NMR) spectra are recorded on Agilent DD2 500 spectrometers, with working frequencies of 500 MHz for ¹H and 125 MHz for ¹³C nuclei, respectively. Chemical shifts are reported in ppm relative to the signals corresponding to the residual non-deuterated solvents (CD₃CN: δ_{H}=1.94 ppm and δ_{C}=118.26 ppm for ¹³CN). High-resolution mass spectra (HR-ESI) were measured on a Finnigan LCQ iontrap mass spectrometer.

### Synthetic Protocols

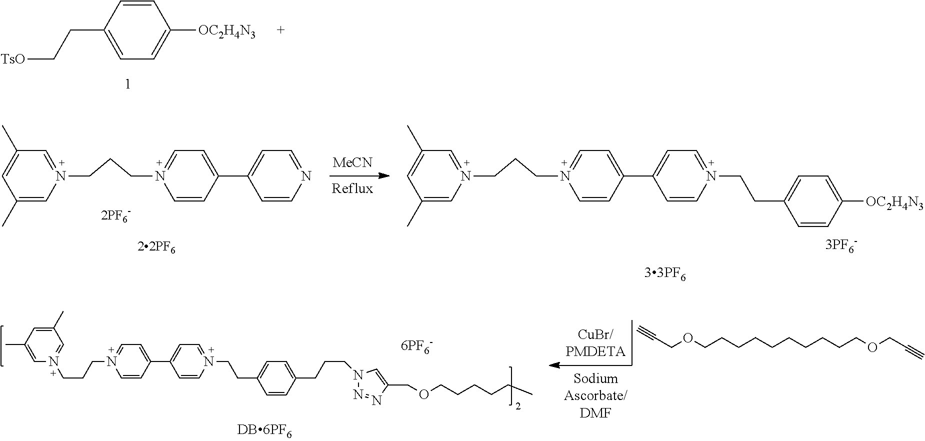

3·3PF₆: Compound 1^{S5} (180 mg, 0.50 mmol) and 2·2PF₆^{S1} (446 mg, 0.75 mmol) were dissolved in MeCN (10 mL) in a 50-mL round-bottomed flask and stirred under reflux for 48 h. After the solvents were removed in vacuo, the crude product was purified using reverse-phase flash chromatography (C₁₈: H₂O/MeCN 0.1% TFA 0-100%), followed using anion exchange from TFA⁻ to PF₆⁻ by treating the aqueous fractions with an excess of NH₄PF₆, resulting in a white precipitate which was collected by centrifugation and washed with H₂O several times before being dried in vacuo to afford 3·3PF₆ as an off-white solid (327 mg, 71%). ¹H NMR (500 MHz, CD₃CN, 298 K): δ 8.92 (d, J=7.7, 2H), 8.75 (d, J=7.7, 2H), 8.43 (d, J=7.6, 2H), 8.40 (s, 2H), 8.34 (d, J=7.5, 2H), 8.23 (s, 1H), 7.12 (d, J=8.4, 2H), 6.92 (d, J=8.3, 2H), 4.86 (t, J=7.1, 2H), 4.72 (t, J=7.9, 2H), 4.58 (t, J=7.6, 2H), 4.16 (t, J=4.8, 2H), 3.62 (t, J=4.9, 2H), 3.31 (t, J=7.1, 2H), 2.67 (quint, J=7.7, 2H), 2.53 (s, 6H). ¹³C NMR (125 MHz, CD₃CN, 298 K): δ 158.8, 148.2, 146.7, 146.5, 142.4, 140.4, 131.1, 128.8, 128.4, 127.9, 116.0, 68.0, 64.2, 59.2, 58.6, 51.0, 36.9, 32.6, 18.3. ESI-HRMS for 3·3PF₆; Calcd for C₃₀H₃₅F₁₈N₆OP₃: m/z=785.2150 [M−PF₆]⁺; found: 785.2158.

DB·6PF₆: 3·3PF₆ (200 mg, 0.21 mmol), 1,10-bis(prop-2-yn-1-yloxy)decane^{S4} (25 mg, 0.60 mmol), Cu(MeCN)₄PF₆ (7.5 mg, 0.020 mmol), sodium ascorbate (4.0 mg, 0.020 mmol), and N,N,N,N″,N″-pentamethyldiethyl-enetriamine (PMDETA) (3.5 mg, 0.020 mmol) were dissolved in DMF (6 mL) in a 20-mL vial. The solution was stirred at room temp under a N₂ atmosphere for 24 h. Excess of TBACl was added to the solution and the solids were collected by filtration. The crude product was purified by reverse-phase flash chromatography (C₁₈: H₂O/MeCN 0.1% TFA 0-100%), followed by anion exchange from TFA⁻ to PF₆⁻ by treating the aqueous fractions with an excess of NH₄PF₆, resulting in a white precipitate which was collected by centrifugation and washed with H₂O several times before being dried in vacuo to afford DB·6PF₆ as an off-white solid (176 mg, 82%). ¹H NMR (500 MHz, CD₃CN, 298 K): δ 8.93 (d, J=7.7, 4H), 8.75 (d, J=7.7, 4H), 8.45 (d, J=7.7, 4H), 8.40 (s, 4H), 8.34 (d, J=7.5, 4H), 8.23 (s, 2H), 7.85 (s, 2H), 7.10 (d, J=8.4, 4H), 6.86 (d, J=8.3, 4H), 4.85 (t, J=7.8, 4H), 4.75-4.72 (m, 4H), 4.58 (t, J=7.6, 4H), 4.53 (s, 4H), 4.39 (t, J=4.8, 4H), 3.48 (t, J=4.9, 4H), 3.28 (t, J=7.1, 4H), 2.70 (quint, J=7.7, 4H), 2.53 (s, 12H), 1.56-1.53 (m, 4H), 1.30-1.28 (m, 12H). ¹³C NMR (125 MHz, CD₃CN, 298 K) δ 158.5, 151.3, 150.7, 148.2, 146.7, 146.5, 145.8, 142.4, 140.4, 131.1, 129.0, 128.4, 128.0, 127.9, 124.9, 124.8, 116.0, 71.0, 67.4, 64.5, 64.4, 64.1, 59.2, 58.6, 50.3, 36.8, 33.5, 32.6, 30.3, 30.2, 30.2, 30.2, 30.1, 30.0, 26.8, 26.6, 24.2, 20.2, 18.3, 13.7. ESI-HRMS for DB·6PF₆; Calcd for C₇₆H₉₆F₃₆N₁₂O₄P₆: m/z=910.3117 [M−2PF₆]²⁺; found: 910.3130.

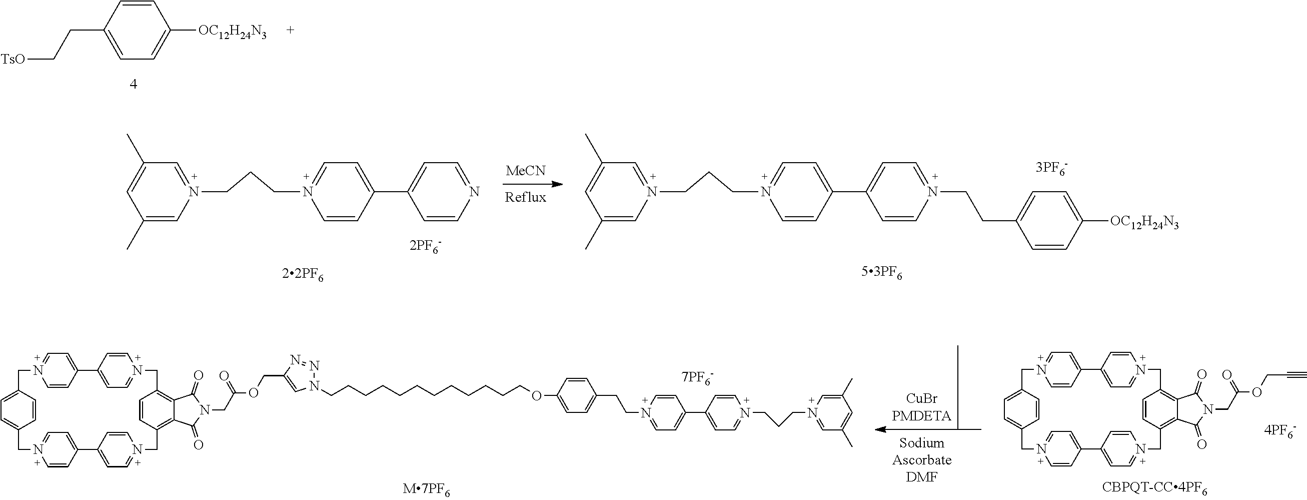

5·3PF₆: Compound 4^{S5} (250 mg, 0.50 mmol) and 2·2PF₆^{S1} (446 mg, 0.75 mmol) were dissolved in MeCN (10 mL) in a 50-mL round-bottomed flask and stirred under reflux for 48 h. After the solvents were removed in vacuo, the crude product was purified using reverse-phase flash chromatography (C₁₈: H₂O/MeCN 0.1% TFA 0-100%), followed by anion exchange from TFA⁻ to PF₆⁻ by treating the aqueous fractions with an excess of NH₄PF₆, resulting in a white precipitate which was collected by centrifugation and washed with H₂O several times before being dried in vacuo to afford 5·3PF₆ as an off-white solid (385 mg, 73.3%). ¹H NMR (500 MHz, CD₃CN, 298 K): δ 8.92 (d, J=7.6, 2H), 8.75 (d, J=7.7, 2H), 8.44 (d, J=7.7, 2H), 8.40 (s, 2H), 8.34 (d, J=7.5, 2H), 8.23 (s, 1H), 7.10 (d, J=8.4, 2H), 6.88 (d, J=8.3, 2H), 4.85 (t, J=7.1, 2H), 4.73 (t, J=7.9, 2H), 4.58 (t, J=7.6, 2H), 3.96 (t, J=4.8, 2H), 3.32-3.28 (m, 4H), 2.69 (quint, J=7.7, 2H), 2.53 (s, 6H), 1.75 (quint, J=7.7, 2H), 1.62-1.58 (m, 2H), 1.37-0.98 (m, 16H). ¹³C NMR (125 MHz, CD₃CN, 298 K): δ 159.6, 151.4, 150.7, 148.2, 146.7, 146.5, 142.4, 140.4, 131.0, 128.4, 127.9, 127.9, 118.2, 115.8, 68.8, 64.2, 59.2, 58.6, 52.1, 36.9, 32.5, 30.19, 30.18, 30.15, 30.11, 30.0, 29.9, 29.7, 29.4, 27.3, 26.6, 24.2, 20.2, 18.3, 13.7. ESI-HRMS for 5·3PF₆; Calcd for C₄₀H₅₅F₁₈N₆O P₃: m/z=925.3715 [M−PF₆]⁺; found: 925.3729.

M·7PF₆: 5·3PF₆ (106 mg, 0.10 mmol), CBPQT-CC·4PF₆^{S4} (127 mg, 0.10 mmol), Cu(MeCN)₄PF₆ (3.8 mg, 0.010 mmol), sodium ascorbate (2.0 mg, 0.010 mmol), and PMDETA (1.8 mg, 0.010 mmol) were dissolved in DMF (5 mL) in a 20-mL vial. The solution was stirred at room temp under N₂ atmosphere for 24 h. Excess of TBACl was added to the solution, and then the solids were collected by filtration. The crude product was purified by reverse-phase flash chromatography (C₁₈: H₂O/MeCN 0.1% TFA 0-100%), followed by anion exchange from TFA⁻ to PF₆⁻ by treating the aqueous fractions with an excess of NH₄PF₆, resulting in a white precipitate which was collected by centrifugation and washed with H₂O several times before being dried in vacuo to afford M·7PF₆ as an off-white solid (189 mg, 81.2%). ¹H NMR (500 MHz, CD₃CN, 298 K): δ 8.94 (d, J=6.9, 2H), 8.89 (d, J=6.6, 8H), 8.79 (d, J=7.6, 2H), 8.44 (d, J=6.4, 2H), 8.41 (s, 2H), 8.36 (d, J=7.5, 4H), 8.23 (s, 2H), 8.20 (d, J=6.4, 4H), 8.14 (d, J=6.5, 4H), 8.10 (s, 2H), 7.87 (s, 1H), 7.51 (s, 4H), 7.12 (d, J=8.5, 4H), 6.89 (d, J=8.5, 4H), 6.21 (s, 4H), 5.77 (s, 4H), 5.28 (s, 2H), 4.84 (t, J=7.8, 2H), 4.73 (t, J=7.7, 2H), 4.58 (t, J=7.6, 2H), 4.29 (t, J=7.8, 2H), 4.32 (s, 2H), 3.96 (t, J=6.6, 2H), 3.29 (t, J=7.3, 2H), 2.69 (quint, J=7.7, 2H), 2.53 (s, 6H), 1.91 (quint, J=7.7, 2H), 1.76 (quint, J=7.6, 2H), 1.46 (quint, J=7.7, 2H), 1.35-1.32 (m, 14H). ¹³C NMR (125 MHz, CD₃CN, 298 K) δ 167.9, 167.6, 159.6, 151.4, 150.7, 148.2, 146.9, 146.7, 146.5, 146.0, 142.5, 142.4, 140.4, 138.6, 136.9, 134.3, 131.5, 131.04, 130.99, 128.4, 128.4, 128.01, 127.96, 127.9, 125.4, 118.2, 118.0, 115.8, 68.9, 65.5, 64.1, 60.2, 59.6, 59.2, 58.6, 50.9, 40.0, 36.9, 32.6, 30.9, 30.3, 30.3, 30.2, 30.1, 30.0, 29.7, 27.1, 26.7, 18.3. ESI-HRMS for M·7PF₆; Calcd for C₈₃H₉₀F₄₂N₁₁O₅P₇: m/z=1022.7662 [M−2PF₆]²⁺; found: 1022.7672.

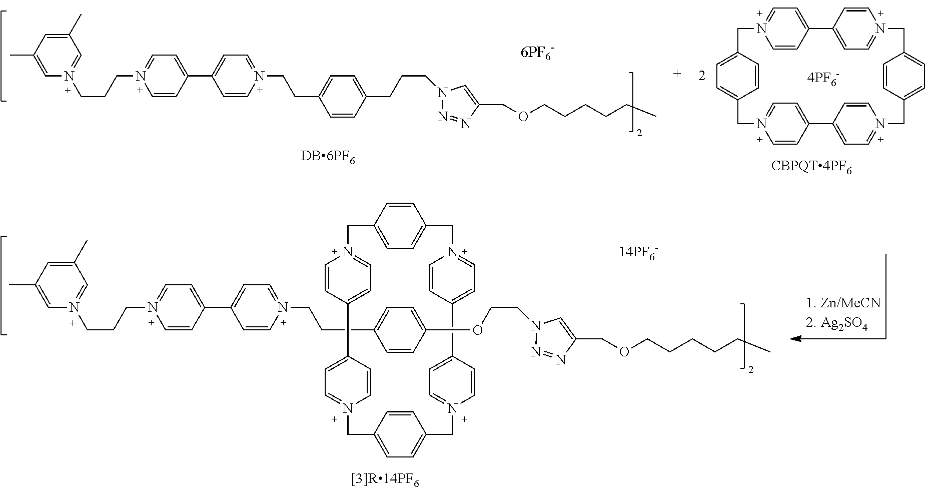

[3]R·14PF₆: DB·6PF₆ (11 mg, 0.10 mmol) and CBPQT·4PF₆^{S2} (12 mg, 0.22 mmol) were dissolved in MeCN (0.40 mL) in a N₂-filled glovebox. Excess of Zn dust was added to the solution, and the resulting mixture were stirred at room temp for 10 min. After removing the Zn dust by filtration, excess of Ag₂SO₄ was added to the deep purple solution under stirring to produce a yellow colored solution. Excess of TBACl was added to the solution, and then the solids were collected by filtration. The crude product was purified by reverse-phase flash chromatography (C₁₈: H₂O/MeCN 0.1% TFA 0-100%), followed by anion exchange from TFA⁻ to PF₆⁻ by treating the aqueous fractions with an excess of NH₄PF₆, resulting in a white precipitate which was collected by centrifugation and washed with H₂O several times before being dried in vacuo to afford [3]R·14PF₆ as an light yellow solid (16 mg, 74%). ¹H NMR (500 MHz, CD₃CN, 298 K): δ 9.22 (d, J=6.8, 2H), 9.10 (d, J=7.0, 2H), 8.96 (d, J=6.7, 8H), 8.66 (d, J=6.9, 2H), 8.60 (d, J=7.0, 2H), 8.43 (s, 2H), 8.25 (s, 1H), 8.12 (s, 1H), 7.90 (d, J=6.6, 2H), 7.87 (s, 8H), 5.84-5.77 (m, 8H), 5.07 (d, J=8.3, 2H), 4.83 (s, 2H), 4.74 (t, J=5.0, 2H), 4.67-4.60 (m, 4H), 4.75 (t, J=7.0, 2H), 3.36 (t, J=5.0, 2H), 2.95-2.91 (m, 2H), 2.77-2.72 (m, 2H), 2.71 (d, J=8.4, 2H), 2.55 (s, 6H), 1.69 (quint, J=7.5, 2H), 1.37-1.30 (m, 6H). ¹³C NMR (125 MHz, CD₃CN, 298 K) δ 154.9, 151.1, 151.0, 147.9, 147.6, 146.4, 146.2, 145.9, 145.7, 145.5, 142.1, 140.1, 137.7, 131.3, 130.1, 128.3, 128.0, 127.9, 127.9, 127.2, 127.0, 125.7, 112.5, 71.9, 65.8, 65.5, 64.2, 62.2, 50.0, 58.3, 49.7, 35.0, 32.2, 30.1, 30.0, 26.5, 18.0. ESI-HRMS for [3]R·14PF₆; Calcd for C₁₄₈H₁₆₀F₈₄N₂₀O₄P₁₄: m/z=1291.9658 [M−3PF₆]³⁺; found: 1291.9674.

### Binding Constant Measurement

The binding constant of 5^{·2+}⊂CBPQT^{2(+·)} was determine by Vis/NIR titration in MeCN following a previously reported⁵ protocol in J. Am. Chem. Soc. 2016, 138, 8288-8300.

### REFERENCES

(1) Cheng, C.; McGonigal, P. R.; Liu, W. G.; Li, H.; Vermeulen, N. A.; Ke, C.; Frasconi, M.; Stern, C. L.; Goddard III, W. A.; Stoddart, J. F. Energetically demanding transport in a supramolecular assembly. J. Am. Chem. Soc. 2014, 136, 14702-14705.
(2) Asakawa, M.; Dehaen, W.; L′abbé, G.; Menzer, S.; Nouwen, J.; Raymo, F. M.; Stoddart, J. Improved Template-Directed Synthesis of Cyclobis(paraquat-p-phenylene). J. Org. Chem. 1996, 61, 9591-9595.
(3) Wang, Y; Sun, J.; Liu, Z.; Nassar, M. S.; Botros, Y. Y.; Stoddart, J. F. Radically promoted formation of a molecular lasso. Chem. Sci. 2017, 8, 562-2568.
(4) Chwalek, M.; Auzély, R.; Fort, S. Synthesis and biological evaluation of multivalent carbohydrate ligands obtained by click assembly of pseudo-rotaxanes. Org. Biomol. Chem. 2009, 7, 1680-1688.
(5) Cheng, C.; Cheng, T.; Xiao, H.; Krzyaniak, M. D.; Wang, Y; McGonigal, P. R.; Frasconi, M.; Barnes, J. C.; Fahrenbach, A. C.; Wasielewski, M. R. Goddard III, W. A. Stoddart, J. F. Influence of constitution and charge on radical pairing interactions in trisradical tricationic complexes. J Am. Chem. Soc. 2016, 138, 8288-8300.

1. A daisy chain polymer comprising a multiplicity of kinetically trapped or host-guest paired molecular-pump-containing monomers, wherein the molecular-pump-containing monomers comprise a molecular pump having a recognition site and a Coulombic barrier.

2. The daisy chain polymer of claim 1, wherein the molecular-pump-containing monomers further comprise a redox-active macrocyclic component and a collecting chain,
wherein the collecting chain links the molecular pump and redox-active macrocyclic component and
wherein—
(i) the redox-active macrocyclic component of at least one of the multiplicity of molecular-pump-containing monomers is kinetically trapped on the collecting chain of another molecular-pump-containing monomer or
(ii) the redox-active macrocyclic component of at least one of the multiplicity of molecular-pump containing monomers is host-guest paired with the recognition site of another molecular-pump-containing monomer.

3. The daisy chain polymer of claim 2, wherein the recognition site comprises a viologen subunit and/or the Coulombic barrier comprises a dimethylpyridinium.

4. The daisy chain polymer of claim 2, wherein the redox-active macrocyclic component comprises a cyclobis(paraquat-p-phenylene) (CBPQT) macrocycle.

5. The daisy chain polymer of claim 4, wherein the molecular-pump-containing monomers are

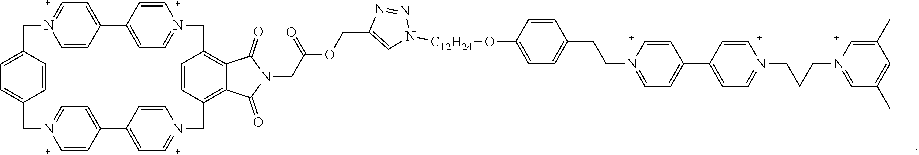

6. The daisy chain polymer of claims 1, wherein the molecular-pump-containing monomers comprise two molecular pumps and a collecting chain joining the two molecular pumps and the daisy chain polymer further comprises a multiplicity of macrocyclic monomers, the macrocylic monomers comprising two redox-active macrocyclic components and a chain joining the two redox-active macrocyclic components, and
wherein—
(i) at least one of the redox-active macrocyclic components of one of the multiplicity of macrocyclic monomers is kinetically trapped on the collecting chain of one of the multiplicity of molecular-pump-containing monomers or
(ii) at least one of the redox-active macrocyclic components of one of the multiplicity of macrocyclic monomers is host-guest paired with the recognition site of one of the multiplicity of molecular-pump-containing monomers. 7 (Original) The daisy chain polymer of claim 6, wherein the recognition site of each of the molecular pumps comprises a viologen subunit and/or the Coulombic barrier of each of the molecular pumps comprises a dimethylpyridinium.

8. The daisy chain polymer of claim 7, wherein the molecular pump containing monomers are

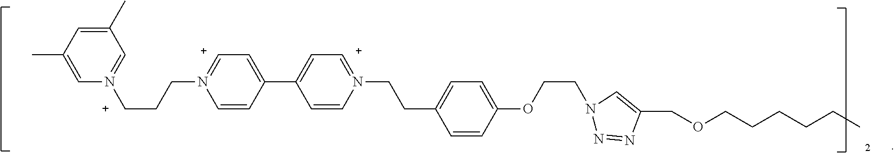

9. The daisy chain polymer of claim 7, wherein each of the redox-active macrocyclic components comprise a cyclobis(paraquat-p-phenylene) (CBPQT) macrocycle.

10. The polymer of claim 1, wherein the daisy chain polymer has a degree of polymerization of 3 or greater.

11. The polymer of claim 1, wherein the daisy chain polymer is prepared with an energy ratchet mechanism.

12. A composition for preparing a daisy chain polymer, the composition comprising a plurality of molecular-pump-containing monomers according to claim 1.

13. The composition of claim 12, wherein the molecular-pump-containing monomers further comprise a redox-active macrocyclic component and a collecting chain, wherein the collecting chain links the molecular pump and redox-active macrocyclic component.

14. The composition of claim 13, wherein the molecular-pump-containing monomers are

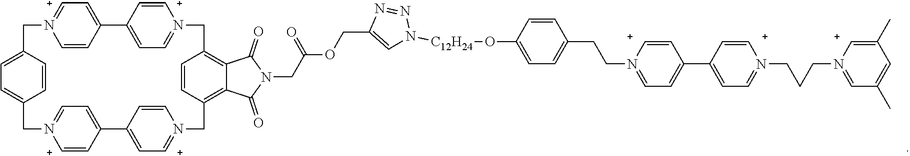

15. The composition of claim 12, wherein the molecular-pump-containing monomers comprise two molecular pumps and a collecting chain joining the two molecular pumps and the composition further comprises a plurality of macrocyclic monomers, the macrocylic monomers comprising two redox-active macrocyclic components and a chain joining the two redox-active macrocyclic components.

16. The composition of claim 15, wherein the molecular pump containing monomers are

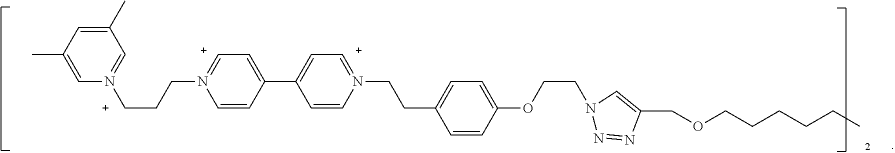

17. The composition of claim 12, wherein the recognition site comprises a viologen subunit; the Coulombic barrier comprises a dimethylpyridinium; the redox-active macrocyclic component comprises a cyclobis(paraquat-p-phenylene) (CBPQT) macrocycle; or any combination thereof.

18. A method of preparing a daisy chain polymer, the method comprising reducing a plurality of molecular-pump-containing monomers with a reducing agent, thereby host-guest pairing a multiplicity of molecular-pump-containing monomers.

19. The method of claim 18, further comprising oxidizing the multiplicity of host-guest paired molecular-pump-containing monomers, thereby kinetically trapping the multiplicity of molecular-pump-containing monomers.

20. (canceled)

21. (canceled)

22. A method of depolymerizing a daisy chain polymer comprising oxidizing a multiplicity of host-guest paired molecular-pump-containing monomers with an oxidizing agent, thereby detreading the multiplicity of molecular-pump-containing monomers.

23. The method of claim 22 further comprising reducing a multiplicity of kinetically trapped molecular-pump-containing monomers to prepare the multiplicity of host-guest paired molecular-pump-containing monomers.

24. (canceled)

25. (canceled)
